(19) United States
(12) Patent Application Publication
(10) Pub. No.: US 2005/0193451 A1
(43) Pub. Date: Sep. 1, 2005

(54) Articulating arm for medical procedures

(75) Inventors: Jens U. Quistgaard, Seattle, WA (US); Tim Etchells, Bothell, WA (US); Gregory Paul Darlington, Snohomish, WA (US); Charles S. Desilets, Edmonds, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LIPOSONIX, INC., Bothell, WA (US)

(21) Appl. No.: 10/751,344

(22) Filed: Dec. 30, 2003

(51) Int. Cl. B25J 9/00

(52) U.S. Cl. 901/9

(57) ABSTRACT

An apparatus for precise positioning of a medical device is disclosed. The apparatus comprises a base, an articulating arm, a position sensor and a means for load balancing. The apparatus may also include a robotic driver and an additional rhythmic motion sensor. The apparatus is used to carry a therapy head for a medical procedure requiring precise positioning of a therapy head, precise movement of a therapy head, or use of a therapy head over a patient body for an extended period of time.

### CROSS-REFERENCES TO RELATED APPLICATIONS

The subject matter of the present application is related to that of the following applications each of which is being filed on the same day as the present application: 10/______, entitled “Medical Device Inline Degasser” (Attorney Docket No. 02356-000500US); 10/______, entitled “Disposable Transducer Seal” (Attorney Docket No. 02356-000700US); 10/______, entitled “Acoustic Gel with Dopant” (Attorney Docket No. 02356-000800US); 60/______, entitled “Position Tracking Device” (Attorney Docket No. 021356-000900US); 60/______, entitled “Method for Planning and Performing Ultrasound Therapy” (Attorney Docket No. 021356-001000US); 60/______, entitled “Ultrasound Therapy with Hood Movement Control” (Attorney Docket No. 021356-001100US); 60/______, entitled “Systems and Methods for the Destruction of Adipose Tissue” (Attorney Docket No. 021356-001200US); 60/______, entitled “Component Ultrasound Transducer” (Attorney Docket No. 021356-001300US); the full disclosure of each of these applications are incorporated herein by reference.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention relates to an articulating arm for use in a non-invasive medical procedure.

2. Background of the Present Invention

Presently there are numerous methods and device used by medical and dental professionals to keep a medical device in close proximity to a patient during a procedure. These devices are largely deployed by hand, positioned by hand and rely on tension mechanisms to maintain their position relative to the patient.

Among the prior art, there are few articulating arms used in the medical industry for maintaining the precise location of an effector at the tip of an articulating arm to a patient. Articulating arms are used in various other industries such as manufacturing, machine tooling and robotic applications. Applications in manufacturing for heavy lifting and repetitive tasks may use robotic arms or load balancing arms. Robotic arms are capable of performing repetitive tasks and tasks involving heavy lifting so that a user is not burdened with performing these operations. Robotic arms are programmable so they can move autonomously between two or more positions. Generally a user programs the arm to move between a first position and any number of secondary positions so the robotic arm can carry out numerous tasks. Robotic arms are used on assembly lines to move parts from supply areas to assembly areas, and to secure parts to each other in assemblies, such as in the production of automobiles, circuit boards and other mass produced items. Robotic arms generally use encoders or other position sensors so the machine controlling the arm, be it a variable stage computer program or a simple electronic controller, know where the robotic arm is and how much it needs to be moved to perform its task. While robotic arms are enormously useful devices, they are primarily used in assembly and routine repetitive tasks. There are few robotic arms having the delicate and intricate movement ability as is demanded and required in medical procedures.

U.S. Pat. No. 4,291,578 describes an articulating arm for use with an ultrasound probe. The probe is used to guide an invasive insertion (needle or catheter) and the arm has a spring responsiveness giving it a light touch for easy use. The arm is attached to a vertical support extending from a pivoting and weighted base incorporated into a bed. The reach of the arm is restricted to the top half (torso) of the patient body.

U.S. Pat. No. 6,488,030 describes an apparatus for use in a medical biopsy procedure. An articulating arm is used having a stage or platform at the end that includes a micro-advancement control for ultra fine advancement of a biopsy probe. The arm is positioned manually in relation to the patient and the platform on the articulating arm is designed for use with a minimally invasive procedure.

Various instruments designed for minimally invasive procedures also utilize robotic or semi-autonomous features. However these devices are not suited for purely noninvasive procedures.

The difference between a load balancing arm and a robotic arm can be indistinct. Generally load balancing arms enable a user to grab and move loads directly in a natural manner. The weight of the load is compensated for so the user feels the load is within his or her natural lifting capacity. The load balancing arm provides the advantage of allowing a human user to guide the arm to move objects in a natural manner. That is to say, load balancing arms are designed primarily to assist a user in moving heavy objects by supplementing a person's lifting ability, and moving in the same motions a human being normally makes. The closer the load balancing arm lifting force is to the weight of the load, the less force the user is required to exert on the arm to move the load. Because load balancing arms are generally assisting devices that rely on a user to guide and control their movement, there is no need for any sort of position control or tracking of the movement of a load balancing arm. Some arms used for providing industrial measurement of solid objects provide limited forms of counter weighting and position encoders, however these devices are not designed for carrying any sort of substantial loads, nor do they provide for any form of adaptive positioning.

Thus there are no robotic arms or load balancing arms that provide a combination of; feather touch, location controller and location awareness in real time, and with the ability and design for use in a medical environment.

Thus there remains a need in the art for a device that can provide a full range of motion over a patient body, allowing a physician or user to place an effector at the end of an articulating arm, and to control its precise relational position with the patient, and control the position either manually or automatically.

There is also a need for a device that can provide adaptive positioning and match the regular movement of a patient body (e.g. breathing) so that the effector of the articulating arm does not change position relative to the patient during the course of the procedure unless specifically intended to do so by the physician.

There is further a need for an articulating arm for medical procedures having a load balancing mechanism for procedures of extended duration, or procedures requiring an effector to be properly positioned and provide a hands free environment for the user to do something else.

There is still further a need for a controller to provide a closed loop controller for the precise control of the effector in relationship to both the patient and the external environment. At least one of these needs is addressed by the following disclosure.

### BRIEF SUMMARY OF THE INVENTION

It is an object of the present invention then to provide for an articulating arm that combines a closed loop control feature of a robotic arm with the feather touch of a load balancing arm.

It is further an objective of the present invention to provide for a means of determining position of an articulating arm in real time and on a continuing basis.

It is still a further objective of the present invention to provide for an articulated arm that can be used in a lengthy medical procedure allowing for a physician to have his or her hands free for other tasks.

It is yet another objective of the present invention to provide for an articulating arm with adaptive positioning abilities, capable of moving with the a patient during an extended medical procedure while simultaneously recording the position of the articulating arm and an effector in real time.

Yet another objective of the present invention is to provide for an articulating arm capable of resuming an automated sequence of movement commands regardless of interruptions to the sequence.

These and other objectives are met by the various embodiments of the present invention. In a first embodiment, an apparatus for carrying a load during a medical procedure, comprises a base, an articulating arm having a distal end and a proximal end secured in a movable fashion to the base. At least one positional encoder is incorporated into the arm; and a receptacle is disposed at the distal end for carrying an effector. The arm is load balanced when the effector is engaged, and a controller is connected to the positional encoder(s) to track the position of the arm in real time.

In a second embodiment, an apparatus for precise positioning of a medical device comprises a base, a robotic articulating arm having a base end attached to the base and an unsecured end attached to an effector/therapy head capable of holding one or more medical devices, at least one sensor is located substantially near the unsecured end and capable of determining the precise position of the effector relative to a patient and the base, and a controller in electronic communication with the motion sensor wherein the precision location controller utilizes data from the motion sensor to control the robotic articulating arm to maintain the location of the one or more medical device relative to the patient in real time.

A method of controlling an articulating arm through at least one force generating device comprises determining a desired position for the articulating arm to achieve. The desired position is expressed as a plurality of component coordinates, and a first time position coordinate is calculated for each of the plurality of components. A force changing command to the force generating device is transmitted, and a subsequent time position coordinate for each of the plurality of components is calculated. The subsequent time position coordinate is coupled to the desired position and the force changing commands are adjusted, usually continuously, until the articulating arm achieves the desired position.

### BRIEF DESCRIPTION OF THE DRAWINGS

FIG. 1 is an illustration of the basic embodiment.

FIG. 2A and 2B show two alternative embodiments.

FIG. 2C illustrates the range of motion of the present apparatus.

FIG. 3 is an illustration of a wall mounted articulating arm.

FIG. 4-6 illustrated additional alternative embodiments.

FIG. 7 is an illustration of the motion range of the unsecured end and therapy head relative to a patient body during a medical procedure.

### DETAILED DESCRIPTION OF THE INVENTION

The apparatus disclosed below is an articulating arm designed for use with medical instruments and devices. The articulating arm has a receptacle or other adaptor on its distal end to receive an effector or therapy head. Collectively we refer to any attachment or instrument to be used with the arm as a “therapy head.” The therapy head may be a simple instrument such as a scalpel, electronic stethoscope or a complex medical device. The therapy head may have a complex structure that includes independent articulating elements, and a plurality of medical instruments. One embodiment envisioned is to use the articulating arm of the present invention in combination with a therapy head having a motorized ultrasound transducer array contained with in a housing that includes motors, a water circulation system, a series of detectors and a diagnostic and therapeutic ultrasound transducer. While this is only one possible embodiment, it provides an example of a therapy head that will have substantial mass, and for which the articulating arm will have to adapt to. The articulating arm is designed to provide location information and load balancing for what ever therapy head is attached to the arm. In the following discloser, all discussion of an effector, therapy head or combination refers to any device that may be coupled to the distal end of the articulating arm for a medical procedure.

The position information provided includes a three dimensional coordinate position linked to an orientation of the effector or therapy head. This allows the articulating arm to have continuous feedback on the location in space, and orientation of the effector. The information is used by the system to track the movement of the effector, and to provide location control data to a closed loop controller. Thus discussions herein describing position include orientation as an optional element that is recorded and calculated by the closed loop controller.

In the principle embodiment there is an apparatus for carrying a load during a medical procedure. The apparatus comprises a base for securing an articulating arm. The articulating arm has a proximal end secured in a movable fashion to the base, and a distal end. There is at least one positional encoder incorporated into the arm. A receptacle is located at the distal end for carrying a therapy head. Finally there is a means for load balancing the arm when the therapy head is engaged such that the positional encoder(s) are able to track the position of the arm in real time.

The apparatus uses one or more position encoders to track the movement of the articulating arm. The position encoders should be highly sensitive and capable of tracking position changes as small as 1 mm or less. Rotational encoders are preferred and are included in the joints of the articulating arm so that movement of each individual arm segment relative to either the base, or another arm segment, or to the therapy head, can be tracked. Rotational encoders measure the degree or angle change between the arm segments when ever the articulating arm is moved. By tracking the change in angle between the moving parts, and knowing the fixed length of each of the arm segments, the position of any joint can be determined using mathematical calculations. If there is a therapy head or other effector secured to the articulating arm via a joint having an encoder as well, then changes in the angle of the joint will assist in accurately determining the position of the therapy head. While rotational encoders are perhaps the most straight forward means for tracking the position of the arm, other types of encoders would work as well.

The load balancing can take either an active or passive form. In a passive form, the means for load balancing comprises mechanical structures that provide counter balancing to changes in the articulating arm position during use. The mechanical structures ensure the arm is always sufficiently balanced to prevent the therapy head from moving due to gravity, joint slippage or hysteresis of the arm. The arm has a means for load balancing that encompasses known methods and devices for creating or maintaining force. The force generated is used for the load balancing and can be active force generating devices (e.g. any sort of motor) or a passive force generating device (e.g. a spring and counter weight, or some sort of pressure cylinder). The exact form of the force generating device or method is not particularly critical since the invention relies on force generating methods and devices that are well established in their respective arts.

The arm is attached to a weighted base having sufficient mass to anchor the arm regardless of the position and angle the arm is moved to when the therapy head is attached. Thus the arm may be at its maximum extension and at an angle to cause the maximum shift in the center of gravity, however the base shall be sufficiently weighted or anchored such that the arm will not tip over or become unstable. The joint used to attach the arm to the base allows rotational movement of the arm relative to the base, and/or inclination and declination of the arm relative to the base. The joint between the base and the proximal end of the arm includes a means for load balancing in the form of a passive or active force generating device(s).

The arm comprises two or more segments, and a load balancing mechanism is used between each segment either independently (each segment is self balancing with respect to the other segments of the arm) or dependently (each segment balances in combination with one or more adjacent segments). Load balancing for the distal most arm segment must also adjust for the therapy head and any positional changes it may create during a medical procedure. It should be self evident that in order to maintain the load balancing feature the weight of the therapy head attached to the distal end of the arm must not exceed the weight compensating ability of the load balancing means. Similarly the range of motion of the arm itself should be restricted to prevent the arm from becoming unbalanced. The load balancing mechanism should compensate for both the load of the therapy head and the change in the center of gravity as the therapy head is extended away from the base in a horizontal plane (the most unbalancing configuration). Preferably the load balancing mechanism also compensates for any hysteresis that may accompany the movement of the arm. Thus the greater the ability of the load balancing means, the greater range of motion allowable on the articulating arm. Using the encoders of the arm to determine position it is possible to control the range of motion of the arm depending on the weight of the therapy head. The therapy head itself may provide data to the articulating arm in the form of a data chip which can be read by the arm. The data chip may contain information as to the mass of the effector or therapy head, as well as to its operational design. That is too say, each time a new therapy head is attached to the distal end of the arm, the movement controller of the arm is “smart” and can figure out what range of motion will be allowed. Thus range of motion limitations or “stops” can be implemented on the arm using either the load balancing device in the case it can be electronically controlled, or the controller can issue a warning when the range of motion is approaching the acceptable limit. Such warning may be an audible tone, warning light or other means easily communicated to a user. Alternatively a mechanical stop can be set either manually or automatically to physically inhibit the movement of the arm beyond the balanced range prior to the beginning of a medical procedure.

The data generated by the encoders are relayed to a controller. The controller is a computerized device, running either software or hardware or a combination of both, to provide the apparatus with a position tracking device or a closed loop control mechanism. In passive mode, the controller does not provide active force to the articulating arm, instead it provides a signal to a user as to where the arm should be moved, or should not be moved.

In the passive mode, the load balancing means can be simple weights and springs running inline with the articulating arm so that the movements in the arm will produce a corresponding change in position of a weight and/or spring or in the arm itself if desired. Using an independent passive load balancing mechanism is preferred. In this manner each arm segment balances simultaneously with all other arm segments when the arm is moved.

In a dependent passive mode, a series of springs and weights may again be used, however it would be more efficient to use a series of gas, hydraulic or pneumatic motors designed to relax when pressure is applied to the distal end of the arm (or therapy head) or in response to the activation of a trigger mechanism. Pressure or force from these passive force generating devices is re-established once the arm has been manually placed in a desired position. The pressure or force on the arm segments prevents the arm from moving again until an operator releases the standing pressure or force.

In yet another embodiment, an active load balancing mechanism can be used using any kind of active force generating device (such as air/hydraulic cylinders or pneumatic motors). These can operate either independently or dependently based on the commands provided by a user through a robotic driver. An advantage to the active load balancing mechanism is the way the articulating arm can compensate the positioning of the arm automatically during a procedure while leaving the therapy head in the desired position. For example, when a user wishes to change the roll, pitch or yaw of the therapy head to match the local contours of the patient body, this may be done by moving the therapy head within the joint used to connect the therapy head to the distal end of the arm. Changes in the orientation of the therapy head can cause minute or significant changes to the balance of the articulating arm depending on the size and weight of the therapy head. Using an active load balancing mechanism, the robotic driver can adjust for the changes in the therapy head orientation without changing the position of the distal end of the arm.

The encoders provide data of the position of the apparatus to a closed loop controller. The controller is a method of controlling an articulating arm through at least one force generating device comprising the steps of first, determining a desired position for the articulating arm to achieve. Second the controller breaks down the desired position into a plurality of component coordinates. Third the controller calculates a first time position coordinate for each of the plurality of components. Fourth transmitting a force changing command to a force generating device. Fifth calculating a subsequent time position coordinate for each of the plurality of components. Sixth comparing the subsequent time position coordinate to the desired position and finally continually adjusting said force changing commands until said articulating arm achieves said desired position.

The position encoder of the present invention may be mechanical or optical encoders included incorporated into the arm itself, or it can be one or more feedback devices that are used external to the arm. Alternative embodiments of the encoder include using one or more optical devices for tracking the position of the arm as it moves. The arm would incorporate a plurality of optically readable tags that the sensors could readily identify and track. Another alternative is there can be a single RF transmitter at the tip of the proximal end, and an RF receiver located in the base, or in a fixed location externally. The RF data would allow the controller to track the movement of the distal end and know where the effector is positioned. Such embodiments, and any equivalents, are not considered as preferred embodiments, but are still well within the scope of the present disclosure.

The controller may be a software application or hardware device (or combination of the two) that receives the data from the encoders and calculates the position of the therapy head. The controller can also calculate the position of each individual segment of the apparatus, and map the movement of the apparatus in space. Since the encoders are in electronic communication with the controller, the data for knowing where the therapy head occurs essentially in real time. The delay in computer processing of the data is minute and too small an interval for a user to detect. Even in the course of doing a medical procedure, no procedure that is currently manually conducted by a physician would experience any noticeable or operable delay using the present invention.

In addition to calculating the position of the apparatus in space, the controller can provide movement information to the arm by acting as a robotic controller for any actuated control components of the apparatus. The controller can also receive data from an external feed, or read information from a data file. In this manner the controller can act as a robotic controller to follow real time commands from a user or another computer, or read a data file that provides a map or series of movement commands that the therapy head must follow. Furthermore if the therapy head requires precise activation at particular coordinates, the controller can handle these operations as well.

The distal end has a therapy head attached to it. The attachment must be secure, but should also be removable so that the therapy head can be removed between procedures, or interchangeable for different procedures. The range of motion between the therapy head and the distal end of the articulating arm can likewise be determined using a rotational encoder in the joint connecting the therapy head to the articulating arm. The joint between the therapy head and the articulating arm may have multiple rotational joints, or a ball joint to allow greater mobility of the therapy head. Encoders in each joint, or an encoder capable of accurately gauging the change in angle in a three dimensional joint, provides the needed information to determine the exact position of the therapy head. Similarly, once angle and distance from the base are determined, it is a simple matter to include any additional information such as the length of a particular medical device from the last encoder in the chain going from base to distal end, and thus determining the exact three dimensional coordinate position of the effector or therapy head.

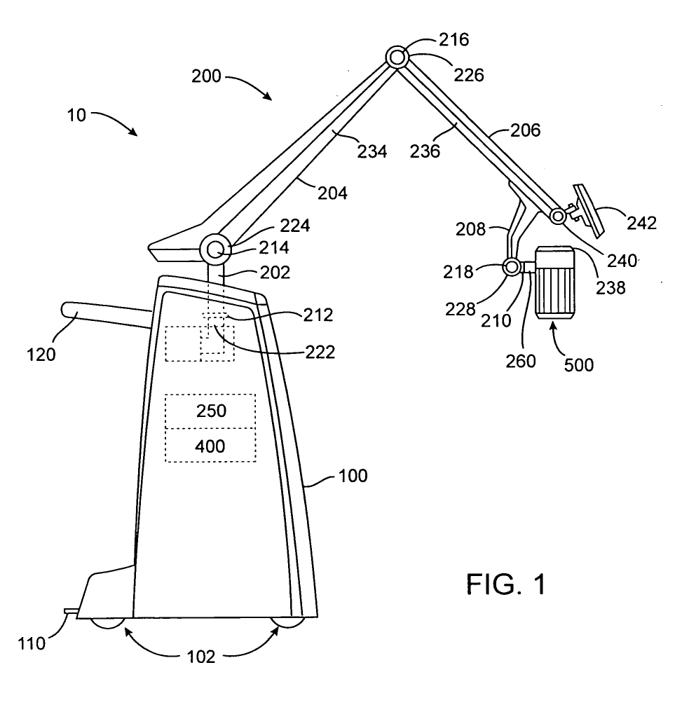

A first embodiment is illustrated in FIG. 1. A base 100 is supported by castors 102 allowing the apparatus 10 to be mobile. Supported in the base 100 is a computer device 400 having a controller 250. Optionally the base 100 may have a handle 120 for easy manipulation or movement of the apparatus 10, and a brake 110 for securing the castors 102 in place. The articulating arm 200 is secured to the base 100 at a first joint 212. The joint 212 has an encoder 222 for determining the position changes of the joint 212. The first joint 212 may be a rotating joint or a ball joint allowing more than two degrees of freedom. Extending from the first joint 212 is a support member 202. The support member is linked to a second joint 214, having a second encoder 224 and movably connected to a arm segment 204. The next arm segment 206 is rotationally connected to the joint 216 and encoder 226. Continuing down the length of the arm there is a distal arm segment 208 attached to a retainer 260 for the end effector/therapy head 500. The effector/therapy head 500 is held firmly in place by the retainer 260 during operation. An angle joint 210 can be used to allow the effector/therapy head 500 to be moved in additional degrees of freedom beyond what the distal joint 218 provides for, or the degrees of freedom can be combined into a single joint (not shown).

A base force generating device 232 can be used to generate force to provide for load balancing for the first joint 212, or it can be a system of force generating devices providing force through the length of the arm and for each arm segment. Force generation occurs to maintain the position of the joints and is incorporated into the arm as either a single force generating device (where force generating device 232 extends through out the articulating arm 200) or where there are separate individual force generating devices such as shown 234, 236, 238.

An example of a single force generating device 232 that may be used through out the articulating arm 200 would be a mechanical motor controlling a plurality of tension arms through out the articulating arm. Alternatively the tension arms may be passive and operate independently without a single control device.

Optionally a display device 242 may be positioned near the distal end of the arm 208 providing visual feedback and information display to a user during a medical procedure.

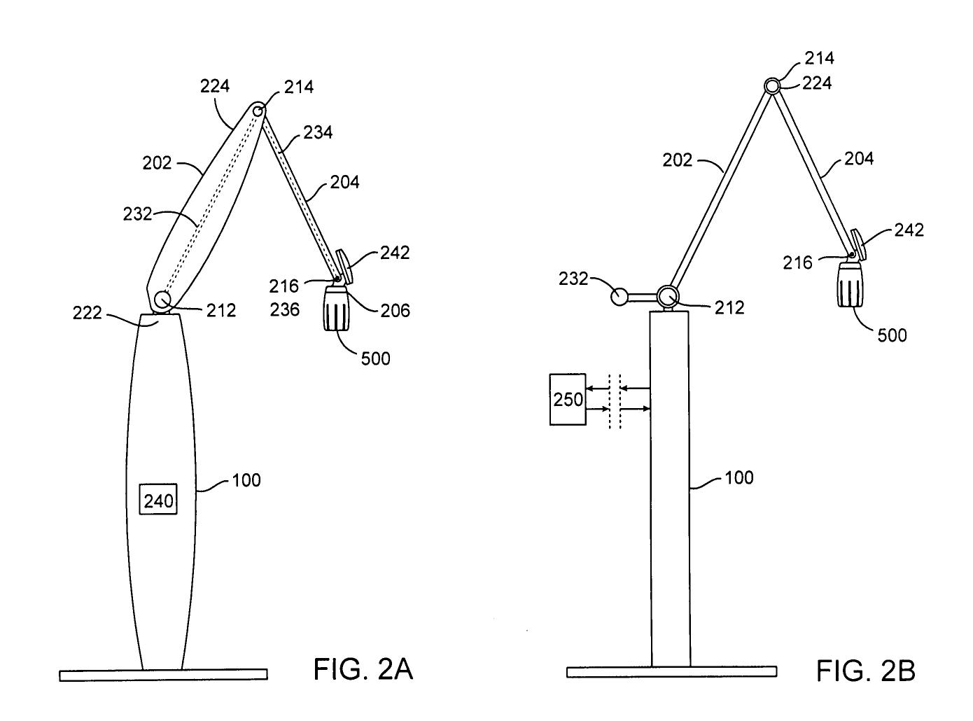

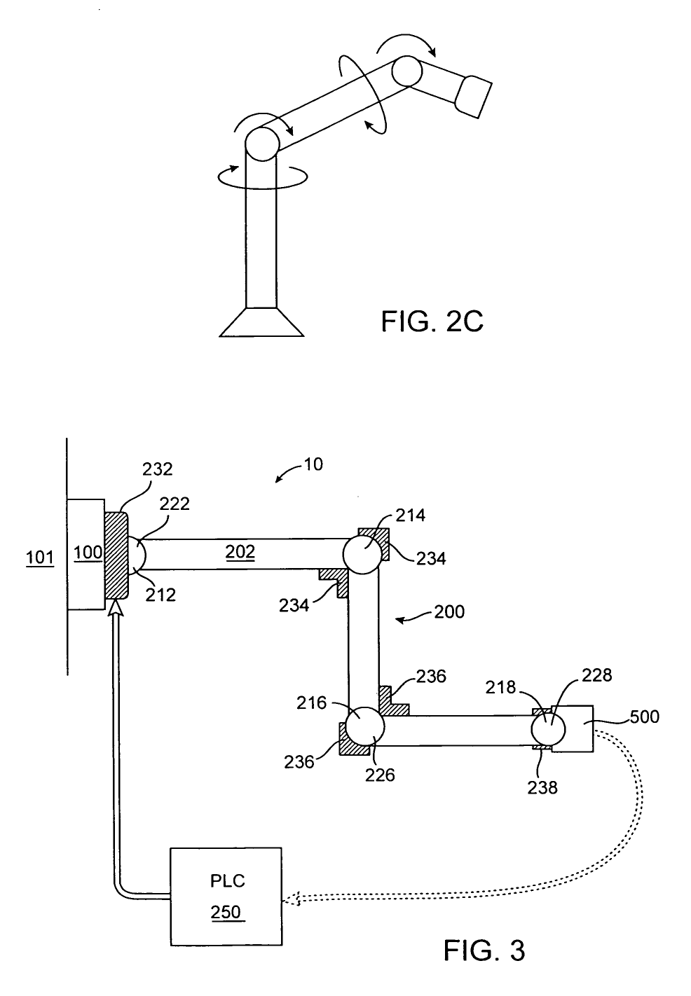

FIG. 2A illustrates an alternative embodiment having a stationary base 100 with a controller 250 incorporated therein. This embodiment has an articulating arm 200 extending from the base 100 and having a first joint 212, and an encoder 222 for the joint 212. The first arm segment 202 incorporates a load balancing force generating device 232. There is a second arm segment 204 connected to the first segment 202 at second joint 214. A second encoder 224 is located within the arm, and a second force generating device 234 is incorporated into the second arm segment 204. The effector/therapy head 500 is attached at the distal end of the arm 206, having a distal joint 216 with an encoder 226 incorporated into the joint. Again a display device 242 is optional.

Another embodiment illustrates the articulating arm having a controller separate from the physical structure of the articulating arm itself (FIG. 2B). Data from the articulating arm 200 can be electronically communicated to the closed loop control device 250 either by hardwire or through a wireless means. The controller 250 here preferably includes a computer device that incorporates additional electronic data and information to provide the needed feedback to the articulating arm in the assistance of the medical procedure.

FIG. 2C provides a simple illustration of the degrees of freedom that the articulating arm has. In this example the arm is shown to have a rotational range with respect to the base 100, and a rotational degree of freedom between the two arm segments. Furthermore angle joint motion is provided between the arm segments allowing for a greater range of motion of the arm itself.

FIG. 3 provides another alternative embodiment of the present invention. Here the articulating arm 200 has a base 100 anchored to a fixture 101 such as a wall. The articulating arm 200 extends from the wall 101 in a substantially horizontal fashion and has a first joint 212 for providing angular and/or rotational movement between the first arm segment 202 and the base 100. Here the first joint 212 is preferably a ball joint or otherjoint capable of providing both horizontal and vertical ranges of movement to the arm. An encoder 222 is provided to track the position of the arm as it moves, and a first force generating device 232 is provided to provide sufficient resistance force to the arm to hold the arm in position after it is moved into place. The force generating device 232 can once again be either active or passive, and it can either provide load balancing so a user or operator can position the effector/therapy head in a desired position, or it can provide active mechanical work to move the effector/therapy head into a programmed position.

Here the apparatus 10 extends substantially parallel from the wall 101 and has a first arm segment 202 linked to a second arm segment 204 via a second joint 214. A position encoder 224 provides data on the relational position of the second arm segment 204 relative to the first arm segment 202. A second force generating device 234 provides the needed force resistance between the first arm segment 202 and second arm segment 204 such that the second arm segment stays in a desired position relative to the first arm 202. A third arm segment 206 is attached via a third arm segment joint 216, complete again with a position encoder 226 and a force generating device 236. The third force generating device provides the requisite resistance to maintain the position of the third arm segment 206 relative to the second arm segment 204. Finally the effector/therapy head 500 is mounted in a retainer or bracket (not shown) allowing a distal end joint 218, having a distal end encoder 228 to track position changes relative to the effector/therapy head and the distal arm segment (third arm segment) 206.

Similar to the previous embodiments, the encoders are able to track the changes in position between one arm segment and the next arm segment and relay that information to a controller 250. The controller coordinates the data from all the position encoder devices and determines the exact position of the effector/therapy head using the angular information from the encoders, along with the known lengths of the various arm segments. It should be. appreciated that there is no maximum limit to the number of arm segments and rotational relationships that can be used with the present invention, although using too many would needlessly over complicate the structure and calculations. However where a medical procedure requires an unusual angle of approach to the patient, additional arm segments and angle calculations can be incorporated.

The controller 250 is shown here as outside the articulating arm 200. The relationship is merely illustrative as previously described the controller may be incorporated into the arm, or it may be an external device. The dotted arrow indicates a data input to the controller 250 and an out put back to the force control device if in case the force generating device is an active device capable of moving the articulating arm in response to electrical commands from the controller.

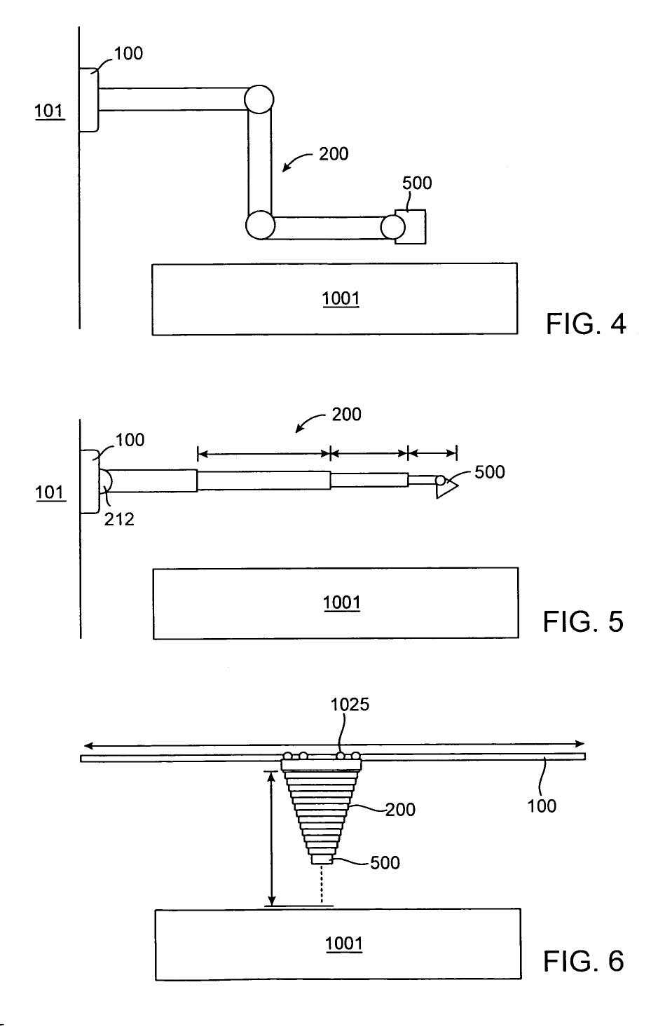

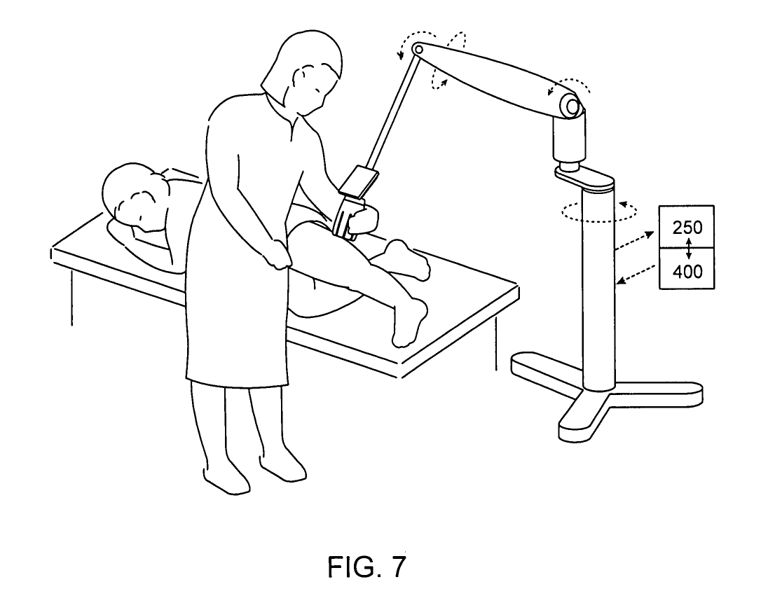

FIGS. 4-6 illustrate various embodiments in relation to a patient bed 1001. FIG. 4 illustrates the same arm as described above (FIG. 3) over the patient bed merely for illustrative purposes. FIG. 5 shows a “lifting crane” type of articulating arm. The articulating arm 200 consists of a plurality of telescoping arm segments 202, 204, 206, 208 while having only a first joint 212 and a distal joint 214. Each joint also has a position encoder (not shown) for determining the final position of the effector/therapy head 500. In this embodiment the extension of each arm segment must be tracked to provide the distance relationship between the two joint encoders. FIG. 6 illustrates an effector/therapy head 500 positioned at the distal end of an accordion like arm following one or more rails serving as the base 100. The accordion like arm provides for a vertical extension and retraction of the effector/therapy head 500 in relation to the patient bed 1001.

These embodiments illustrate the articulating arm 200 requires a base 100 having sufficient mass, or being sufficiently anchored that there is no external motion introduced into the apparatus 10 during a medical procedure. In that regard the base 100 is either sufficiently weighty to anchor the articulating arm 200, or the base 100 is anchored to a fixture 101 so that the base 100 is preferably completely stable. While it is necessary that the base 100 be firmly anchored, and the articulating arm 200, be able to move with confidence relative to the base 100, it is not a requirement that the articulating arm 200 be fixedly attached to the base 100. The base 100 may employ a track, rails or gantry to allow the base end of the articulating arm to move relative to the base 100 (FIG. 4-6), yet still be securely attached to the base 100 so that when the controller 250 corrects the effector/therapy head position of the articulating arm 200, there is no play in the arm movement.

In each of the forgoing embodiments, all necessary cables and component materials needed for the proper use of the medical devices are run either along the length of the arm, or in a manner as to not interfere with the articulating arm's performance. Thus power and communication lines would be run either along the articulating arm, or to the effector/therapy head without impeding the motion or operation of the articulating arm 160.

One alternative embodiment that replaces the encoders of the joints is to use a single position sensor either at the distal end of the articulating arm, or incorporated into the therapy head 500 (similar to the RF transmitter previously described). A location sensor 270 is used to determine the precise location of the therapy head 500. The location sensor 270 envisioned may be one of several types. In one embodiment, the location sensor comprises a single sensor 270 located in the therapy head 500. The location sensor 270 provides precise position information to the controller 250. A plurality of sensors (not shown) located in each joint of the articulating arm may be more appropriate where the apparatus 10 utilizes a multi-segmented arm 200 similar to that shown in FIG. 1. In this embodiment it becomes more important for the controller 250 to determine the location of each “elbow” of the articulating arm so that the various elbows and segments of the arm do not impact the patient, physician or any other equipment near by.

While the location sensor 270 is substantially near the therapy head 500, it is not essential that the location sensor is at the exact tip of the therapy head. Since the controller 250 will maintain the location of the articulating arm 200 to the patient, the location sensor 270 only needs to be within the vicinity of the therapy head 500. Fixed data, such as the distance from the motion sensor 270 to the tip of the therapy head 500, or the tip of a medical device, can be measured and entered into the controller 250. However if desired, the motion sensor could be at the very tip of the therapy head so that it can come into contact with the patient. In this way there is no additional calculation necessary, the position sensor is at the point of patient contact.

A second sensor 272 can be used to determine motion of the patient and provide the controller 250 with the necessary feedback to adjust for the patient's body. This second sensor can be distinguished from the position sensor 270, which provides the articulating arm 200 with the position information in a three dimensional space. The motion sensor 272 identifies the passive or active movement of the human body and allows for corrections. The motion sensor can be any number of sensors that allow the controller 250 to detect and respond to changes in the patient's skin position due to ordinary functions such as breathing. The controller 250 uses the feedback data from the motion sensor 272 and the location sensor 270 in combination to move the articulating arm 200 to precisely match the surface position of the patient. If the articulating arm 200 relies on one or more position encoders 232, 234+, then the controller would use the data from the position encoders in place of a position sensor. This provides the articulating arm with adaptive positioning ability.

Furthermore, if the medical procedure requires the medical devices to move over anarea or volume of the patient body surface, the motion sensor 272 and location sensor 270 must feed sufficient information from the starting point of the procedure, to the controller 250 so the apparatus 10 can accurately adjust for the movement of the patient while at the same time make allowances for the procedure by moving the medical devices through the area or volume required. Once the effector/therapy head is in contact with the patient's body, it is necessary that the articulating arm be responsive to the motion of the patient. That is the patient's body movement must be sufficient to cause the arm to adjust to the contact surface of the patient. One may visualize this by imagining a buoy anchored to a fixed place by an anchor, but tethered to rise and fall with the motion of the oceans waves. In the same manner the effector/therapy head and attached medical instruments ride upon the surface of the patients body in a fixed position, though moving with any natural rhythm of the patient. The motion sensor 272 may utilize a pressure sensor that detects added pressure or release of pressure on the effector/therapy head. This provides the motion sensor with added data and the motion sensor instructs the controller to maintain contact with the patient's skin. The articulating arm can now move with the rhythm of the patient in real time, and maintain its relative position over the cycles of the patient's movement. This can also be partially or wholly accomplished by using a tensioned contact device in the effector/therapy head.

Though the articulating arm is designed to move with a patient, and to have an position tracking device or controller, the apparatus of the present invention may further have a “feather” touch feel so that a physician or other practitioner may move the arm with ease. The articulating arm is either precisely balanced, with accompanying spring tension in the joints so that it may be moved easily, or any robotic movement can be set to support the arm in various positions once a user has moved the articulating arm into a desired position of operation. The feather touch will allow easy manipulation of the articulating arm at any time a user exerts a moving force on the arm. However a safety element is incorporated into the controller so that when the arm is being used in a medical procedure, a limiting position is established so the motors of the articulating arm cannot move the medical devices into the patient. Likewise the articulating arm would resist external forces to change the position of the arm during a medical procedure, as when the arm is inadvertently bumped or jarred.

The medical devices themselves may be adjusted in position using the same mechanical forces used to control the position of the articulating arm. That is, additional servos or micro motors can be used on the medical devices held within the free end. The micro motors can advance the medical devices forward or backward, or move them from side to side or up and down. Where precise control of the arm is not always possible, or where the medical devices require subsequent precise positioning relative to each other, then this embodiment enables that. An example is where a diagnostic ultrasound probe must be used to focus on an area of anatomy while a biopsy probe must be advanced into the patient. Once the biopsy probe is properly positioned a therapeutic ultrasound transducer is engaged in a third position to perform a therapeutic operation. All the while the three components must be held in a precise location relative to the patient body, which is still moving.

A second example of operation is when a therapeutic ultrasound procedure is to be used over a particular surface area of a patient body. The area may be pre-programmed into the controller as a set of coordinates defining the area the articulating arm is permitted to move the effector/therapy head. The effector/therapy head then makes contact with the patient body within the predefined area and automatically engages in a programmed protocol. The controller would provide the necessary data to the articulating arm and effector/therapy head as to motion, speed, duration of therapeutic ultrasound pulses, as well as any other desired data.

In construction, the preferred embodiment of the present apparatus is an articulating arm having a secured base. The base may be secured to either a fixture, a weighted movable cart or other substantially immobile object. If the arm is secured to an object, without a built in base such as a cart, the base may must be secured such that there is danger of the arm becoming unbalanced and tipping over when used. The apparatus may have a weighted base of its own, in which case the base should include casters or other means to allow the apparatus to be moved from place to place. The articulating arm is preferable light weight and easily portable. Construction materials include plastics for the arm segments and metal for the joints and components that will experience higher stress (such as the connector to the therapy head). The electronic communication of the encoders to each other, or to an outside controller such as a computer is carried through wires sealed within the arm segments, or secured to the arm segments so as to not interfere with the movement of the arm. The articulating arm can be made from two or three segments and provide sufficient flexibility for most non-invasive medical procedures. If the arm is to be used for a procedure requiring greater ranges of motion, or the ability to contort in order to facilitate the location of the therapy head, additional segments can be used. Likewise the bulk of the segments may be adjusted during manufacturing to accommodate a preferred procedure.

Alternatively, the robotic articulating arm may constructed following the same guidelines above, or it may be a large device. Again the base is anchored to the floor or a wall, or a table top. The procedure and the types of medical devices used would dictate the size of the robotic articulating arm. Medical devices requiring a more robust support structure would naturally require an arm having a greater load bearing ability, and a greater stability factor incorporated into the base. Smaller devices could use an arm that could be portable and anchored to a table top surface using clamps or similar means.

In use, an operator would be required to attach an effector or therapy head to the articulating arm and insure the effector/therapy head is in the proper position. A variety of specialized device platforms can be customized to be used with the apparatus so that the alignment and positioning of the various medical devices to each other would be correct for the procedure to be performed.

Second the operator would guide the free end of the articulating arm to the patient to be treated. The operator could position the free end with the medical devices in the basic proper alignment and position. Alternatively the free end could be guided to the patient remotely (requiring a robotic style controller) through some manipulation and command of the controller.

In a third alternative, depending on the sophistication of the motion sensor and location tracking information provided to the position location controller, the apparatus could automatically move to the desired position for the start of the medical procedure. Parameters for the procedure would have to be recorded into the position location controller before hand so that the articulating arm could properly follow its programmed instructions.

It may be that each platform designed to hold a variety of medical devices would include a data chip or identifier component so that the apparatus would be able to access a library of procedures based on which attachment was attached to the free end. In this way additional artificial intelligence can be incorporated into the apparatus.

The third step is the actual performance of the medical procedure. Once the effector/therapy head is in place and the medical device platform and medical devices are properly aligned, the medical procedure can begin. The advantage offered by the apparatus is realized here where great precision in relative positioning is required, or where the procedure is simply of an inordinate duration so as to be too tiring for a person to hold a device in the proper alignment.

Alternatively, the articulating arm may be placed into a “free-hand” mode. In this mode an operator may manually move the effector/therapy head of the articulating arm within a pre-programmed space. For example where a therapeutic ultrasound procedure is desired, the operator may program a particular three dimensional space of X, Y and Z coordinates into the controller. The space so defined becomes a limited field of movement that the controller allows the user to manually move the effector/therapy head through. The load balancing or robotic controller of the apparatus prevent a user from straying outside the pre-programmed three dimensional space, while the controller simultaneously keeps track of the precise locations of treatment by reading the transducer firing locations and durations. This allows the computer to map the treatment area, and simultaneously allow the user to manipulate the effector/therapy head. An image map may be displayed so the user can follow along with the computer tracking to treat areas needing therapy while avoiding areas already treated. Since the controller maintains a precise map of treatment hot spots, even if the user moves the effector/therapy head over the same area, the controller can control the transducer and prevent additional treatment to an already treated area, thus the patient receives the full coverage and efficacy of the programmed treatment. An example of a procedure that can benefit from the present invention is the performance of a biopsy using a fine biopsy needle and an imaging ultrasound device. Where the tissue to be sampled is particularly difficult to reach, or requires slow, meticulous navigation, the apparatus of the present invention is ideally suited. Alternatively if a procedure calls for a long duration operation where the medical device is to be moved over the patient body in discrete steps or continuous motion, the articulating arm is well suited to that task. Procedures such as a therapeutic ultrasound application, a directed radiation therapy regime to attack a tumor or the like. A myriad of procedures can benefit from the utilization of the present invention.

The articulating arm of the present invention provides an apparatus that meets the need of a device for precise movement and positioning ability of a therapy head, load balancing and for extended duration or hands free environment for the user. Although the previous description encompasses the preferred embodiments of the invention, it is not possible to enumerate all the equivalent embodiments without an extremely cumbersome disclosure. Thus the specification presented here is not to be considered in a limiting fashion but to be taken in light with the appended claims.

1. An apparatus for carrying a load during a medical procedure, the apparatus comprising:
a base;
an articulating arm having a distal end and a proximal end secured in a movable fashion to said base;
at least one positional encoder coupled to said arm;
a receptacle at the distal end for carrying an effector;
means for load balancing said arm when said effector is engaged; and
a controller coupled to the positional encoder(s) to track the position of the arm in real time.

2. The apparatus as described in claim 1, wherein said controller is a closed loop control device.

3. The apparatus as described in claim 1, wherein said controller is a position tracking device.

4. The apparatus as described in claim 2, wherein said closed loop control device is also able to track orientation of the arm in real time.

5. The apparatus as described in claim 1, wherein the means for load balancing is a robotic driver in electronic communication with said positional encoder(s) wherein the robotic driver can position the articulating arm according to a set of input commands.

6. The apparatus as described in claim 4, wherein said input commands further comprises a series of movement commands for said robotic driver.

7. The apparatus as described in claim 1, wherein the means for load balancing is one or more passive force generating device(s).

8. The apparatus as described in claim 1, wherein the means for load balancing is one or more active force generating device(s).

9. The apparatus as described in claim 1; wherein the means-for load balancing is a combination of one or more passive force generating device(s) and one or more active force generating device(s).

10. The apparatus as described in claim 1, wherein the means for load balancing is one or more cooperative motors.

11. The apparatus as described in claim 1, wherein the means for load balancing is a plurality of springs and counter balancing weights.

12. The apparatus as described in claim 1, wherein the medical procedure is a procedure for the reduction in adipose tissue.

13. The apparatus as described in claim 1, wherein the therapy head includes a high intensity focused ultrasound transducer.

14. The apparatus as described in claim 1, wherein said encoders are in electronic communication with a computer, and said computer controls said means for load balancing.

15. The apparatus as described in claim 1 further comprising a feather touch.

16. The apparatus as described in claim 1, wherein said base is anchored to a wall, ceiling or other fixture.

17. The apparatus as described in claim 1, wherein said base is a cart.

18. The apparatus as described in claim 1, wherein said base is anchored to an examination table.

19. The apparatus as described in claim 1, wherein encoder(s) are rotational encoders incorporated into one or more joints of said articulating arm.

20. The apparatus as described in claim 1, wherein said encoder(s) are linear encoders.

21. The apparatus as described in claim 1, wherein said encoder(s) are one or more position sensors.

22. The apparatus as described in claim 1, further comprising a motion sensor.

23. An apparatus for precise positioning of a medical device comprising:
a base;
a robotic articulating arm having a base end attached to said base and an unsecured end attached to an effector capable of holding one or more medical devices;
at least one position sensor located substantially near said unsecured end and capable of determining the precise position of said effector relative to a patient and said base; and
a controller in electronic communication with said motion sensor;
wherein the controller utilizes data from the sensor to control the robotic articulating arm to maintain the location of the one or more medical device relative to a patient in real time.

24. The apparatus as described in claim 23, wherein the base is anchored to a wall surface.

25. The apparatus as described in claim 23, wherein said robotic articulating arm has a plurality of arm segments separated by a joint between each said arm segment.

26. The apparatus as described in claim 23, wherein the motion sensor tracks the position of each joint of said articulating arm in addition to the procedural end.

27. The apparatus as described in claim 23, wherein said one or more medical devices may be positionally controlled through said controller.

28. The apparatus as described in claim 23, wherein the controller is a computer utilizing a robotic software controller (PLC).

29. The apparatus as described in claim 23, wherein said one or more medical devices consists of at least one ultrasound transducer.

30. The apparatus as described in claim 29, wherein said ultrasound transducer is a therapeutic ultrasound transducer.

31. The apparatus as described in claim 23, further comprising a joint between said base and said base end, so that said base end may be positioned relative to said base.

32. The apparatus as described in claim 23, wherein said articulating arm is a telescoping arm.

33. The apparatus as described in claim 23, wherein said robotic articulating arm is moveable relative to said base.

34. The apparatus as described in claim 23, further comprising an examination table.

35. The apparatus as described in claim 23, wherein the robotic arm may be manually moved with in a programmed limited space, and the articulating elements prevent any manual movement outside the pre-programmed field of movement.

36. The apparatus as described in claim 23, wherein the base is a fixture.

37. The apparatus as described in claim 36, wherein the fixture is a wall, floor or ceiling of a room.

38. A method of controlling an articulating arm through at least one force generating device comprising the steps of:
(a) determining a desired position for said articulating arm;
(b) converting said desired position to a plurality of component coordinates;
(c) calculating a first time position coordinate for each of said plurality of components;
(d) transmitting a force changing command to said force generating device;
(e) calculating a subsequent time position coordinate for each said plurality of components;
(f) comparing said subsequent time position coordinate to said desired position; and
(g) adjusting said force changing commands until said articulating arm achieves said desired position.

39. A method as in claim 38, wherein adjusting said force changing commands occurs continuously.
